(19) United States
(12) Patent Application Publication
(10) Pub. No.: US 2024/0268541 A1
(43) Pub. Date: Aug. 15, 2024

(54) METHOD FOR GENERATING A PHOTOREALISTIC RENDERING OF A COSMETIC PRODUCT

(71) Applicant: L'Oreal, Paris (FR)

(72) Inventors: Sileye Ba, Clichy (FR); Ruowei Jiang, Mississauga (CA); Robin Kips, Clichy (FR)

(73) Assignee: L'Oreal, Paris (FR)

(21) Appl. No.: 18/568,119

(22) PCT Filed: May 9, 2022
(86) PCT No.: PCT/EP2022/062478

§ 371 Date: Dec. 7, 2023

(30) Foreign Application Priority Data
Jun. 8, 2021 (FR) 2106030

(51) Int. Cl. A45D 44/00; G06T 15/20; G06V 10/82

(52) U.S. Cl. CPC A45D 44/005; G06T 15/205; G06V 10/82

(57) ABSTRACT

According to one aspect, what is proposed is a method for generating a photorealistic rendering of a cosmetic product, comprising: —obtaining (10, 12) a reference image (X_{ref}) of a real cosmetic product (PC) applied to a first person (P1) and at least one source image (X^{j}_{source}) of a second person (P2), —implementing (13) an encoding artificial neural network (E) configured to determine characterizing parameters (E(X_{ref})) of the cosmetic product (PC) from the reference image (X_{ref}), and then —implementing (14) a realistic physically based rendering engine (R) configured to generate a transformed image (R (X^{j}_{source}, E(X_{ref}))) in which a photorealistic rendering of the cosmetic product (PC) is applied to the person (P2) from said at least one source image (X^{j}_{source}) based on the characterizing parameters (E (X_{ref})) of the cosmetic product (PC) that are determined by the encoding artificial neural network (E).

The invention relates to generating photorealistic renderings of cosmetic products, in particular for an augmented reality application.

Augmented reality denotes artificially superimposing elements computed by a computer system onto a real scene.

Augmented reality may be used to obtain an overview of a result of the element computed by the computer system being present in the real scene.

One possible application of augmented reality is that of a computer system superimposing a virtual cosmetic product on a person. Such superimposition makes it possible to have an overview of the application of the cosmetic product to the person. It is thus possible for a person to virtually try out cosmetic products.

For example, the cosmetic product may be a make-up product (blusher, foundation, mascara, lipstick, gloss, nail varnish, eyeliner, etc.). The cosmetic product may also be a haircare product such as a dye.

It is difficult to realistically generate and apply a virtual cosmetic product to a person.

In order to simplify the application of virtual cosmetic products to a person, virtual cosmetic products are generally limited to predefined products, in particular to products having predefined shades and colours. Such a solution therefore has the drawback of not allowing a user to virtually try out cosmetic products that are not provided among the predefined products.

To resolve this drawback, some methods have been proposed for virtually applying a cosmetic product to a person based on a reference image of another person to whom the cosmetic product is actually applied. It has in particular been proposed to use complex artificial neural networks configured to extract the appearance of the cosmetic product from the reference image and then to virtually apply the extracted cosmetic product to the image of another person.

Such artificial neural networks require a significant amount of computing resources to be implemented. Furthermore, the execution time of these neural networks is relatively lengthy. This solution thus cannot generally be implemented on portable appliances, for example smartphones, to obtain rendering of the virtual cosmetic product in real time.

In addition, the quality of the renderings able to be achieved using such artificial neural networks is strongly dependent on the data used to train these artificial neural networks. For example, the renderings may fail when the cosmetic product to be generated virtually has unusual colours.

Moreover, it is possible to use rendering engines based on physical principles to generate realistic renderings of cosmetic products. These rendering engines are referred to using the expression “realistic physically based rendering engine”. It is difficult to correctly configure such rendering engines such that they generate a given cosmetic product realistically. Indeed, it is then necessary to define characterizing parameters of the cosmetic product in order to provide them to the rendering engine. Defining these characterizing parameters is difficult and tedious.

There is therefore a need to propose a simple solution for generating photorealistic renderings of cosmetic products from an image of a real cosmetic product applied to a person, in particular in real time with limited computing resources.

According to one aspect, what is proposed is a method for generating a photorealistic rendering of a cosmetic product, comprising:
obtaining a reference image of a real cosmetic product applied to a first person and at least one source image of a second person,
implementing an encoding artificial neural network configured to determine characterizing parameters of the cosmetic product from the reference image, and then
implementing a realistic physically based rendering engine, configured to generate a transformed image in which a photorealistic rendering of the cosmetic product is applied to the person from said at least one source image based on the characterizing parameters of the cosmetic product that are determined by the encoding artificial neural network.

The method may be used to generate photorealistic renderings of cosmetic products of various types on a person. For example, the method may be used to generate photorealistic renderings of make-up products or haircare products on a person. In particular, the make-up products may be blusher, foundation, mascara, lipstick, gloss, nail varnish or eyeliner. The haircare product may be a dye.

The rendering engine is configured to generate a photorealistic rendering of a cosmetic product on a person based on certain parameters of the cosmetic product. Such a rendering engine is conventional and well known to those skilled in the art.

The method thus implements an artificial neural network trained to automatically extract parameters of the cosmetic product from the reference image. These parameters make it possible to configure the rendering engine so as to generate a photorealistic rendering of the cosmetic product on the person.

The method therefore makes it possible to obtain a photorealistic rendering of a cosmetic product for any cosmetic product forming part of the cosmetic product type for which the rendering engine is designed. The virtual cosmetic products able to be generated are therefore not limited to a few predefined cosmetic products.

The artificial neural network that is used has the advantage of needing few computing resources to be executed, in comparison in particular with conventional methods using inverse graphics networks in which a gradient descent is performed.

The proposed method may therefore be implemented by appliances with low computational capabilities, in particular by portable appliances, for example smartphones, tablets, etc.

Advantageously, said at least one source image is obtained using a photography device. Furthermore, the transformed image is displayed on a screen.

In one advantageous mode of implementation, the cosmetic product is a make-up product for the lips. The parameters of the vector may then be an opacity, a colour, a reflection intensity, an amount and a texture of the make-up product for the lips.

According to another aspect, what is proposed is a method for training an encoding artificial neural network as described above, comprising:
obtaining predefined characterizing parameters associated with a cosmetic product and a source image of a person,
implementing a realistic physically based rendering engine as described above, configured to generate a transformed image in which a photorealistic rendering of the cosmetic product is applied to the person from the source image based on the predefined characterizing parameters,
implementing the encoding artificial neural network in order to determine the characterizing parameters of the cosmetic product from the transformed image,
a first comparison between the characterizing parameters determined by the encoding artificial neural network and the predefined characterizing parameters,
adapting the weights of the encoding artificial neural network based on a result of this first comparison.

In one advantageous mode of implementation, the method for training the encoding artificial neural network furthermore comprises:
implementing a rendering artificial neural network trained to imitate the rendering engine, this rendering artificial neural network being configured to generate a transformed image in which a photorealistic rendering of the cosmetic product is applied to the person from the source image based on the characterizing parameters of the cosmetic product that are determined by the encoding artificial neural network,
a comparison between the transformed image generated by the rendering artificial neural network and the transformed image generated by the rendering engine, and wherein the weights of the encoding artificial neural network are also adapted based on a result of this second comparison.

According to another aspect, what is proposed is a computer program product comprising instructions that, when the program is executed by a computer, prompt said computer to:
obtain a reference image of a real cosmetic product applied to a first person and at least one source image of a second person,
implement an encoding artificial neural network configured to determine characterizing parameters of the cosmetic product from the reference image, and then
implement a realistic physically based rendering engine configured to virtually generate a photorealistic rendering of the cosmetic product applied to the person shown in said at least one source image based on the characterizing parameters of the cosmetic product that are determined by the encoding artificial neural network.

According to another aspect, what is proposed is a system comprising:
a memory storing the computer program product as described above and the reference image,
a processing unit configured to implement the computer program product,
a photography device configured to acquire said at least one source image,
a screen configured to display the transformed image generated by the realistic physically based rendering engine.

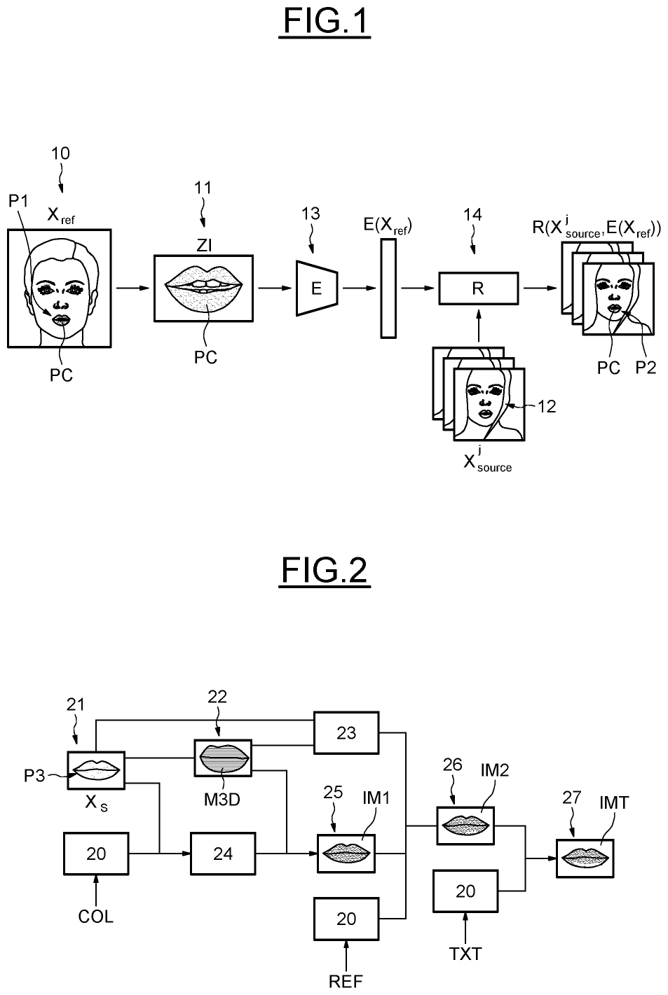

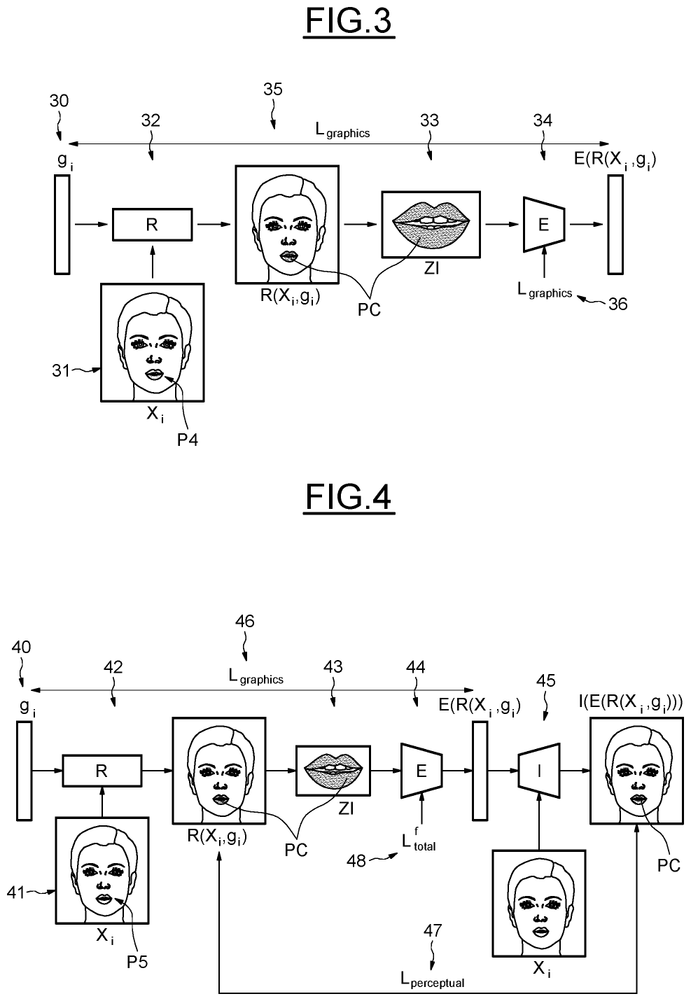

Further advantages and features of the invention will become apparent upon examining the detailed description of modes of implementation and embodiments, which are in no way limiting, and the appended drawings, in which:

[FIG. 1],

[FIG. 2],

[FIG. 3],

[FIG. 4],

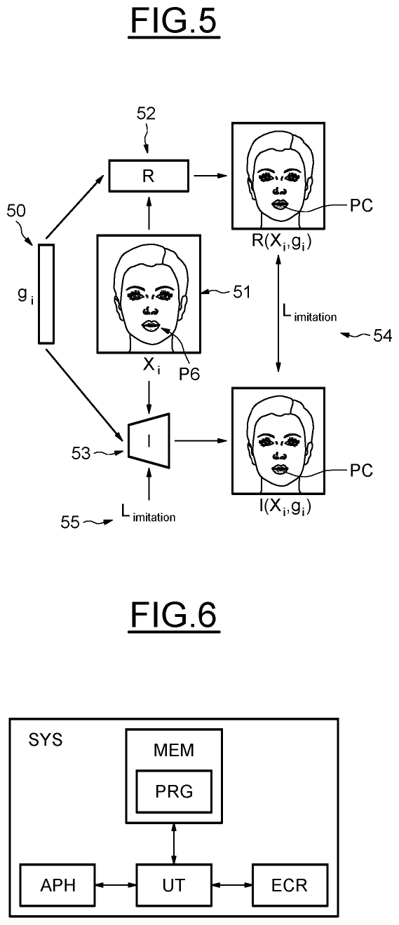

FIG. 5 and

FIG. 6 schematically illustrate embodiments and modes of implementation of the invention.

FIG. 1 illustrates one mode of implementation of a method for generating a photorealistic rendering of a cosmetic product.

The cosmetic product may be a make-up product for the face or a haircare product. In particular, the make-up products may be blusher, foundation, mascara, lipstick, gloss or eyeliner. The haircare product may be a dye.

The rendering generation method comprises obtaining 10 a reference image X_{ref}. The reference image X_{ref} is an image of a real cosmetic product PC applied to a person P1. For example, when the cosmetic product is a make-up product for the face or a haircare product, the reference image X_{ref} may be a portrait of a person to whom the make-up product or the haircare product is applied. In this case, the cosmetic product is a lipstick.

The method may comprise defining 11 an area of interest ZI of the reference image X_{ref}, the area of interest ZI corresponding to the area of the reference image in which the cosmetic product PC is located, in this case the mouth of the person P1 to whom the lipstick is applied.

The method also comprises obtaining 12 at least one source image X_{source}^{j}. Said at least one source image X_{source}^{j} is at least one image of a person P2 to whom the cosmetic product from the reference image is not applied. It is for example possible to obtain a single source image or else a sequence of images of a video.

The rendering generation method makes it possible to virtually apply the cosmetic product PC from the reference image to the person P2 from said at least one source image X_{source}^{j}.

In particular, the rendering generation method comprises implementing 13 an encoding artificial neural network E. This encoding artificial neural network E is trained to extract characterizing parameters of a cosmetic products from an image received at input of this encoding artificial neural network.

The characterizing parameters make it possible to define the features of the cosmetic product present in the image received at input. For example, when the cosmetic product is a make-up product for the lips, in particular a lipstick or a lip gloss, the characterizing parameters may be chosen from among an opacity, a colour, a reflection intensity, an amount and a texture (roughness) of the make-up product for the lips.

The encoding artificial neural network E is for example a convolutional neural network.

Various modes of implementation of a method for training the encoding artificial neural network E will be described hereinafter with reference to FIGS. 3 and 4.

More particularly, in the rendering generation method, the encoding artificial neural network is implemented by taking the reference image or the defined area of interest of the reference image at input. The encoding artificial neural network E then makes it possible to determine characterizing parameters associated with the cosmetic product PC shown in the reference image X_{ref} or in the area of interest of the reference image. These characterizing parameters are shown in a vector E(X_{ref}).

The rendering generation method then comprises implementing 14 a rendering engine R.

The rendering engine R is configured to receive at least one source image and characterizing parameters of a cosmetic product at input. The rendering engine R is also configured to generate a photorealistic rendering of a cosmetic product on the person shown in said at least one source image at output based on the characterizing parameters provided at input.

The rendering engine R is therefore configured to generate at least one transformed image, carrying over said at least source image, and in which the generated cosmetic product is applied virtually to the person shown in said at least one source image.

The generated cosmetic product then has the features defined by the characterizing parameters provided at input of the rendering engine R.

In particular, in the rendering generation method, the rendering engine R is implemented by receiving said at least one source image X_{source}^{j} and the vector E(X_{ref}) of characterizing parameters determined by the encoding artificial neural network at input. The rendering engine then makes it possible to generate at least one transformed image R(X_{source}^{j}, E(X_{ref})) depicting the person P2 from said at least one source image X_{source}^{j} to whom the cosmetic product PC shown in the reference image X_{ref} is virtually applied.

Such a rendering method may be used by a user to virtually try out a cosmetic product. The provided source image X_{source}^{j} is then an image of this user, for example their portrait. The user may provide, as reference image, an image of a person to whom the cosmetic product that the user wants to virtually try out is applied.

The rendering generation method may also be used to simply generate vectors of characterizing parameters of a cosmetic product from a reference image X_{ref}. These vectors of characterizing parameters may then be used at input of a rendering engine when a user wishes to virtually try out the cosmetic product.

FIG. 2 illustrates one mode of implementation of a rendering engine R configured to generate a photorealistic rendering of a make-up products for the lips PM applied to a person P3.

In this embodiment, the rendering engine R receives, in step 20, characterizing parameters relating to the colour COL of the make-up product for the lips PM, to the reflection REF of this product PM and to the texture TXT of this product PM.

The rendering engine R also receives, in step 21, a source image X_{S} of the lips of the person P3. The rendering engine R may then subsequently compute, in step 22, a three-dimensional model M3D of the lips from the source image X_{S}. The rendering engine R may also estimate, in step 23, the reflection of light from the lips from the source image X_{S}.

The rendering engine R then determines, in step 24, corrected colour parameters based on the colour parameters of the make-up product PM that are provided at input. These corrected colour parameters take into account brightness on the lips from the source image.

Next, in step 25, the rendering engine R generates a first intermediate image IM1 in which the rendering engine applies the corrected colour parameters to the lips from the source image, taking into account the previously computed three-dimensional model of the lips.

The rendering engine R then generates, in step 26, a second intermediate image IM2 in which the reflection parameters provided at input are applied to the lips from the first intermediate image IM1, also taking into account the reflection of light from the lips from the source image.

The rendering engine R then generates at output, in step 27, a transformed image IMT in which the texture parameters provided at input are applied to the lips from the second intermediate image.

FIG. 3 illustrates a first mode of implementation of a method for training an encoding artificial neural network E as described above.

The method comprises obtaining 30 at least one predefined vector gᵢ of characterizing parameters representative of the features of a cosmetic product.

The method also comprises obtaining 31 an image Xᵢ. This image Xᵢ shows a person P4 to whom the cosmetic product associated with the predefined vector gᵢ of characterizing parameters is not applied.

The method comprises implementing 32 the rendering engine R described above with reference to FIG. 1. The rendering engine R is implemented by taking the predefined vector gᵢ of characterizing parameters and the image Xᵢ at input.

Implementing 32 the rendering engine R makes it possible to obtain a transformed image R(Xᵢ, gᵢ) in which the cosmetic product PC associated with the vector of characterizing parameters is applied virtually to the person P4 shown in the image Xᵢ.

The method may comprise defining 33 an area of interest ZI of the transformed image R(Xᵢ, gᵢ). The area of interest ZI corresponds to the area of the transformed image R(Xᵢ, gᵢ) in which the cosmetic product is located.

Next, the training method comprises implementing 34 the encoding artificial neural network E described above. The encoding artificial neural network E is implemented by taking the transformed image R(Xᵢ, gᵢ) or the area of interest ZI of this transformed image at input. The encoding artificial neural network E thereby makes it possible to determine characterizing parameters associated with the cosmetic product shown in the transformed image R (Xᵢ, gᵢ) or in the area of interest ZI of the transformed image. These characterizing parameters are shown in a vector E(R(Xᵢ, gᵢ).

The method then comprises computing 35 a cost L_{graphics} (or “loss”) in order to compare the vector E(R(Xᵢ, gᵢ) with the expected vector gᵢ. This comparison makes it possible to determine a difference between the expected values of the vector gᵢ and the values of the vector E(R(Xᵢ, gᵢ) that are determined by the encoding artificial neural network E. In particular, the cost L_{graphics} may be computed using the following formula:

$${L}_{graphics} = \frac{1}{n} {\sum }_{i = 1}^{n} {‖ {g}_{i} - E ( R ( {X}_{i} , {g}_{i} ) ) ‖}_{2}^{2} ,$$

n being equal to the number of vectors gᵢ used.

The training method then comprises adapting 36 the weights of the encoding artificial neural network E, in particular through gradient backpropagation, based on the computed cost L_{graphics}, in order to reduce the difference between the expected values of the vector gᵢ and the values of the vector E(R(Xᵢ, gᵢ) that are determined by the encoding artificial neural network, and therefore to minimize the cost L_{graphics}.

The method may be repeated for various predefined vectors gᵢ and/or for multiple different images Xᵢ in order to improve the performance of the encoding artificial neural network.

FIG. 4 illustrates a second mode of implementation of a method for training an encoding artificial neural network E as described above.

The method comprises obtaining 40 at least one predefined vector gᵢ of characterizing parameters representative of the features of a cosmetic product.

The method also comprises obtaining 41 an image Xᵢ. This image Xᵢ shows a person P5 to whom the cosmetic product associated with the predefined vector gᵢ of characterizing parameters is not applied.

The method comprises implementing 42 the rendering engine R described above with reference to FIG. 1. The rendering engine R is implemented by taking the predefined vector gᵢ of characterizing parameters and the image Xᵢ at input.

Implementing 42 the rendering engine R makes it possible to obtain a transformed image R(Xᵢ, gᵢ) in which the cosmetic product PC associated with the vector of characterizing parameters is applied to the person P5 shown in the image Xᵢ.

The method may comprise defining 43 an area of interest ZI of the transformed image R(Xᵢ, gᵢ), the area of interest ZI corresponding to the area of the transformed image in which the cosmetic product PC is located.

Next, the training method comprises implementing 44 the encoding artificial neural network E described above. The encoding artificial neural network E is implemented by taking the transformed image R(Xᵢ, gᵢ) or the area of interest ZI of this transformed image at input. The encoding artificial neural network E thereby makes it possible to determine characterizing parameters associated with the cosmetic product PC shown in the transformed image R(Xᵢ, gᵢ) or in the area of interest ZI of the transformed image. These characterizing parameters are shown in a vector E(R(Xᵢ, gᵢ).

Next, the training method comprises implementing 45 a rendering artificial neural network I. This rendering artificial neural network I is trained to imitate the rendering engine R. The rendering artificial neural network I is nevertheless distinguishable from the rendering engine R. The rendering artificial neural network I may be a convolutional neural network.

In particular, the rendering artificial neural network I is configured to receive a source image and characterizing parameters of a cosmetic product at input. The rendering artificial neural network is also configured to generate a photorealistic rendering of a cosmetic product on the person shown in the source image at output based on the characterizing parameters provided at input.

The rendering artificial neural network I is therefore configured to generate at least one transformed image, carrying over the source image, and in which the generated cosmetic product is applied virtually to the person shown in said at least one source image.

The generated cosmetic product then has the features defined by the characterizing parameters provided at input of the rendering artificial neural network. The transformed image generated by the rendering artificial neural network is however distinguishable from a transformed image generated by the rendering engine from one and the same vector of characterizing parameters associated with a cosmetic product.

In particular, in the training method, the rendering artificial neural network I is implemented by receiving the source image Xᵢ and the vector E(R(Xᵢ, gᵢ) of characterizing parameters determined by the encoding artificial neural network at input. The rendering artificial neural network then makes it possible to obtain a transformed image I (E(R(Xᵢ, gᵢ))). This transformed image I (E(R(Xᵢ, gᵢ))) then depicts the person from said at least one source image Xᵢ to whom the cosmetic product associated with the vector E(R (Xᵢ, gᵢ) is virtually applied.

The method then comprises computing 46 a first cost L_{graphics} in order to compare the vector E(R(Xᵢ, gᵢ) with the expected vector gᵢ. This comparison makes it possible to determine a difference between the expected values of the vector gᵢ and the values of the vector E(R(Xᵢ, gᵢ) that are determined by the encoding artificial neural network. In particular, the cost L_{graphics} may be computed using the following formula:

$${L}_{graphics} = \frac{1}{n} {\sum }_{i = 1}^{n} {‖ {g}_{i} - E ( R ( {X}_{i} , {g}_{i} ) ) ‖}_{2}^{2} ,$$

n being equal to the number of vectors gᵢ used.

The method also comprises computing 47 a second cost L_{perceptual} in order to compare the transformed image I (E(R(Xᵢ, gᵢ))) generated by the rendering artificial neural network with the transformed image R(Xᵢ, gᵢ) generated by the rendering engine. This comparison makes it possible to determine a difference between the expected transformed image R(Xᵢ, gᵢ) generated from the vector gᵢ and the transformed image I (E(R(Xᵢ, gᵢ))) generated from the vector E(R(Xᵢ, gᵢ) determined by the encoding artificial neural network. In particular, the cost L_{perceptual} may be computed using the following formula:

$${L}_{perceptual} = \frac{1}{n} {\sum }_{i = 1}^{n} {‖ R ( {X}_{i} , {g}_{i} ) - I ( E ( R ( {X}_{i} , {g}_{i} ) ) ) ‖}_{2}^{2} ,$$

n being equal to the number of vectors gᵢ used.

The training method then comprises adapting 48 the weights of the encoding artificial neural network, in particular through gradient backpropagation, based on the computed first cost L_{graphics} and the computed second cost L_{perceptual}.

In particular, the encoding artificial neural network is adapted based on a total cost Lₜₒₜₐₗ^{f} able to be computed using the following formula:

Lₜₒₜₐₗ^{f}=λ₃L_{graphics}+Δ₄L_{perceptual}, where A₃ and A₄ are predefined weighting coefficients.

Such a training method makes it possible to take into account an impact of the characterizing parameters of the vector E(R(Xᵢ, gᵢ) on a transformed image generated from this vector.

It is thereby possible to improve the adaptation of the encoding artificial neural network by taking into account the characterizing parameters having the greatest impact on the transformed image I (E(R(Xᵢ, gᵢ))).

The method may be repeated for various predefined vectors gᵢ and/or for multiple different images Xᵢ in order to improve the performance of the encoding artificial neural network.

The method may be repeated for various predefined vectors gᵢ and/or for multiple different images Xᵢ in order to improve the performance of the encoding artificial neural network.

FIG. 5 illustrates one mode of implementation of a method for training the rendering artificial neural network I.

The method comprises obtaining 50 at least one predefined vector gᵢ of characterizing parameters representative of the features of a cosmetic product.

The method also comprises obtaining 51 an image Xᵢ. This image Xᵢ shows a person P6 to whom the cosmetic product associated with the predefined vector gᵢ of characterizing parameters is not applied.

The method comprises implementing 52 the rendering engine R described above with reference to FIG. 1. The rendering engine R is implemented by taking the predefined vector gᵢ of characterizing parameters and the image Xᵢ at input.

Implementing 52 the rendering engine R makes it possible to obtain a transformed image R(Xᵢ, gᵢ) in which the cosmetic product PC associated with the vector of characterizing parameters is applied to the person P6 shown in the image Xᵢ.

The method comprises implementing 53 the rendering artificial neural network I. The rendering artificial neural network I is implemented by taking the predefined vector gᵢ of characterizing parameters and the image Xᵢ at input.

Implementing the rendering artificial neural network makes it possible to obtain a transformed image I(Xᵢ, gᵢ) in which the cosmetic product PC associated with the vector of characterizing parameters is applied to the person P6 shown in the image Xᵢ.

The method then comprises computing 54 a cost Limitation in order to compare the transformed image I(Xᵢ, gᵢ) generated by the rendering artificial neural network I with the transformed image R(Xᵢ, gᵢ) generated by the rendering engine R. This comparison makes it possible to determine a difference between the transformed image I(Xᵢ, gᵢ) and the expected transformed image R(Xᵢ, gᵢ). In particular, the cost Lₗᵢₘᵢₜₐₜᵢₒₙ may be computed using the following formula:

$${L}_{imitation} = \frac{1}{n} {\sum }_{i = 1}^{n} {‖ R ( {X}_{i} , {g}_{i} ) - I ( {X}_{i} , {g}_{i} ) ‖}_{2}^{2} ,$$

n being equal to the number of vectors gᵢ used.

The training method then comprises adapting 55 the weights of the rendering artificial neural network I, in particular through gradient backpropagation, based on the computed cost Limitation, in order to reduce the difference between the transformed image I(Xᵢ, gᵢ) and the transformed image R(Xᵢ, gᵢ), and therefore to minimize the cost Limitation.

The method may be repeated for various predefined vectors gᵢ and/or for multiple different images Xᵢ in order to improve the performance of the rendering artificial neural network.

FIG. 6 illustrates one embodiment of a system SYS configured to implement a method for generating a photorealistic rendering of a cosmetic product as described above with reference to FIG. 1.

The system SYS comprises a memory MEM storing a computer program PRG. This computer program PRG comprises instructions that, when the program is executed by a computer, prompt said computer to implement the method for generating a photorealistic rendering of a cosmetic product. A reference image is also stored in the memory MEM. This reference image shows a person to whom a cosmetic product is applied.

The system SYS also comprises a photography device APH configured to acquire at least one source image of a person. This source image may then be stored in the memory MEM.

The system SYS comprises a processing unit UT configured to implement the computer program stored in the memory. The processing unit UT is thereby configured to implement the rendering generation method as described above. The processing unit UT is thus configured to generate a transformed image in which a photorealistic rendering of the cosmetic product is applied to the person from the source image based on the reference image stored in memory MEM.

The system furthermore comprises a screen ECR configured to display the transformed image.

The system may for example be a portable appliance, for example a smartphone, an electronic tablet, etc.

1. Method for generating a photorealistic rendering of a cosmetic product, comprising:
obtaining (10, 12) a reference image (X_{ref}) of a real cosmetic product (PC) applied to a first person (P1) and at least one source image (X_{source}^{j}) of a second person (P2),
implementing (13) an encoding artificial neural network (E) configured to determine characterizing parameters (E(X_{ref})) of the cosmetic product (PC) from the reference image (X_{ref}), and then
implementing (14) a realistic physically based rendering engine (R) configured to generate a transformed image (R(X_{source}^{j}, E(X_{ref}))) in which a photorealistic rendering of the cosmetic product (PC) is applied to the person (P2) from said at least one source image (X_{source}^{j}) based on the characterizing parameters (E(X_{ref})) of the cosmetic product (PC) that are determined by the encoding artificial neural network (E).

2. Method according to claim 1, wherein said at least one source image (X_{source}^{j}) is obtained using a photography device (APH), and wherein the transformed image (R(X_{source}^{j}, E(X_{ref}))) is displayed on a screen (ECR).

3. Method according to claim 1, wherein the cosmetic product (PC) is a make-up product for the lips, and wherein the parameters of the vector are an opacity, a colour, a reflection intensity, an amount and a texture of the make-up product for the lips.

4. Method for training an encoding artificial neural network from claim 1, comprising:
obtaining (30, 40, 31, 41) predefined characterizing parameters (gᵢ) associated with a cosmetic product and a source image (Xᵢ) of a person,
implementing (32, 42) a realistic physically based rendering engine (R) according to one of claims 1 to 3, configured to generate a transformed image (R(Xᵢ, gᵢ)) in which a photorealistic rendering of the cosmetic product is applied to the person (P4, P5) from the source image (Xᵢ) based on the predefined characterizing parameters,
implementing (34, 44) the encoding artificial neural network (E) in order to determine the characterizing parameters (E(R(Xᵢ, gᵢ)) of the cosmetic product from the transformed image,
a first comparison (35, 46) between the characterizing parameters (E(R(Xᵢ, gᵢ)) determined by the encoding artificial neural network (E) and the predefined characterizing parameters (gᵢ),
adapting (36, 48) the weights of the encoding artificial neural network based on a result of this first comparison.

5. Training method according to claim 4, furthermore comprising:
implementing (45) a rendering artificial neural network (I) trained to imitate the rendering engine (R), this rendering artificial neural network (I) being configured to generate a transformed image (I (E(R(Xᵢ, gᵢ)))) in which a photorealistic rendering of the cosmetic product is applied to the person (P5) from the source image (Xᵢ) based on the characterizing parameters of the cosmetic product that are determined by the encoding artificial neural network (E),
a comparison (47) between the transformed image (I (E(R (Xᵢ, gᵢ)))) generated by the rendering artificial neural network (I) and the transformed image (R (Xᵢ, gᵢ)) generated by the rendering engine (R),
and wherein the weights of the encoding artificial neural network (E) are also adapted (48) based on a result of this second comparison.

6. Computer program product comprising instructions that, when the program is executed by a computer, prompt said computer to:
obtain a reference image (X_{ref}) of a real cosmetic product (PC) applied to a first person (P1) and at least one source image (X_{source}^{j}) of a second person (P2),
implement an encoding artificial neural network (E) configured to determine characterizing parameters (E(X_{ref})) of the cosmetic product (PC) from the reference image (X_{ref}), and then
implement a realistic physically based rendering engine (R) configured to generate a transformed image (R(X_{source}^{j}, E(X_{ref}))) in which a photorealistic rendering of the cosmetic product (PC) is applied to the person (P2) from said at least one source image (X_{source}^{j}) based on the characterizing parameters (E(X_{ref})) of the cosmetic product (PC) that are determined by the encoding artificial neural network (E).

7. System comprising:
a memory (MEM) storing the computer program product (PRG) according to claim 6 and the reference image (X_{ref}),
a processing unit (UT) configured to implement the computer program product (PRG),
a photography device (APH) configured to acquire said at least one source image (X_{source}^{j}),
a screen (ECR) configured to display the transformed image (R(X_{source}^{j}, E(X_{ref}))) generated by the realistic physically based rendering engine (R).
